(19) United States
(12) Patent Application Publication
(10) Pub. No.: US 2026/0228976 A1
(43) Pub. Date: Aug. 6, 2026

(54) BLENDING METHOD

(71) Applicant: Siemens Industry Software Inc., Plano, TX (US)

(72) Inventors: Adam Nagy, Cambridge (GB); Peter Nanson, Cambridge (GB); Richard Collins, Cambridge (GB)

(21) Appl. No.: 19/152,856

(22) PCT Filed: Feb. 14, 2023
(86) PCT No.: PCT/US2023/012993

§ 371 Date: Jul. 31, 2025

(51) Int. Cl. G06T 17/20

(52) U.S. Cl. CPC G06T 17/20; G06T 2210/56

(57) ABSTRACT

A computer-implemented method for generating a blend surface for a model of a component includes determining a first curve in three-dimensional space, wherein, for each point on the first curve, the distance of the point from a first surface and the distance of the point from a second surface is within a threshold of a pre-determined parameter. The method further includes: determining a second curve comprising a projection of the first curve on to the first surface; determining a third curve comprising a projection of the first curve on to the second surface; generating, based on the first curve, the second curve, and the third curve, a first field function including a signed distance from a point in three-dimensional space to a blend surface between the first surface and the second surface; and generating the blend surface based on the first field function.

The present patent document is a § 371 nationalization of PCT Application Serial No. PCT/US2023/012993, filed Feb. 14, 2023, designating the United States, which is incorporated by reference in its entirety.

### TECHNICAL FIELD

The present disclosure relates to a method for generating a blend surface for a model of a component. In particular, the methods described herein provide a rolling-ball type blend for a model of a component using implicit methods.

### BACKGROUND

Computer-Aided Design (CAD) systems are used in many fields of engineering, manufacturing, and design to create and manipulate solid modelling representations of objects, for example, in additive manufacturing. Modern CAD systems provide a variety of representations of three-dimensional models. Boundary representation (B-rep) technology provides an efficient and adaptable representation of parts by combining classic geometry: analytic surfaces and curves, non-uniform rational basis spline (NURBS) and procedural surfaces and curves; with topology, which captures the connectivity and interaction between geometric elements. In a B-rep, a solid object is represented as a collection of connected surface elements, which define the boundary between interior and exterior points.

Implicit modelling is a modelling technique for representing three-dimensional models using implicit functions. In an implicit model, a surface of the model corresponds to an iso-surface of a function field, ƒ(x), which represents the distance of a point x in three-dimensional space from the surface. Implicit models have a number of advantages over models generated using other modelling techniques. For example, implicit models may be combined easily using Boolean operations.

Meshing is a further modelling technique found in many CAD systems. A mesh representation includes subdivision of a continuous geometric space into discrete geometric and topological cells called facets. Meshes are useful in modelling applications such as finite element analysis, 3D scanning, topology optimization, and 3D printing. Some CAD systems also allow a ‘mixed representation’ that includes classic geometry and facet data in a single B-rep model without conversion between data types.

Blending techniques have been used in CAD systems to create seamless surfaces and smooth out sharp edges and corners in three-dimensional models. Blending may be used to add material to areas of a model to improve physical properties such as mechanical strength. Blending may also be used to improve aesthetic qualities of a surface in a design. Rolling ball blending is a blending technique that generates a blend surface by mimicking the rolling action of a ball along a curve called a spine. The radius of the ball determines a blend radius for the blend surface. Rolling ball blends are straightforward to visualize and have good localization properties allowing a significant degree of control over the blend surface. Unfortunately rolling ball blends are not suited to mesh-based modelling or models that combine B-rep or implicit modelling with mesh-based modelling.

Implicit blending is another blending technique that may be used to generate blends between implicit surfaces. Starting from the field functions for the implicit surfaces, which define the distance from points in space to the implicit surfaces, a blend is generated by combining the field functions of the input surfaces and determining a new isosurface for the blend.

### SUMMARY

It is an object of the disclosure to provide a method for generating a rolling ball type blend for classic and mixed-geometry surfaces using implicit methods.

The scope of the present disclosure is defined solely by the appended claims and is not affected to any degree by the statements within this summary. The present embodiments may obviate one or more of the drawbacks or limitations in the related art.

According to a first aspect, a computer-implemented method for generating a blend surface for a model of a component including a first surface S₀ and a second surface S₁ adjacent to the first surface S₀ is provided. The method includes: determining a first curve C in three-dimensional space wherein for each point on the first curve C the distance of the point from the first surface S₀ and the distance of the point from the second surface S₁ is within a threshold of a pre-determined parameter r, determining a second curve B₀, the second curve B₀ including a projection of the first curve C on to the first surface S₀, determining a third curve B₁, the third curve B₁ including a projection of the first curve C on to the second surface S₁, generating, based on the first curve C, the second curve B₀ and the third curve B₁, a first field function ƒ(x), the first field function ƒ(x) including a signed distance from a point in three-dimensional space to a blend surface S between the first surface S₀ and the second surface S₁, and generating the blend surface S based on the first field function ƒ(x).

The method according to the first aspect provides a rolling-ball type blend for a model of a component using an implicit function definition. The method according to the first aspect is applicable to classical and mesh geometry and may be used to create rolling-ball type blends in models that combine both types of geometry.

According to a second aspect, computer program code is provided. When executed by a data processing system, the code causes the data processing system to carry out the acts of the method according to the first aspect.

In a first implementation form, the first surface S₀ is an isosurface of a second field function ƒ₀ (x) and the second surface is an isosurface of a third field function ƒ₁ (x).

In a second implementation form, determining the first curve C includes determining a fourth field function:

$${f}_{spine} ( x ) = \sqrt{{( {f}_{0} ( x ) - r )}^{2} + {( {f}_{1} ( x ) - r )}^{2}} - λ$$

The implementation further includes generating a mesh based on the fourth field function ƒₛₚᵢₙₑ(x) and generating the first curve C from a plurality of points obtained from the mesh. λ is a parameter such that λ/r is less than a pre-determined value.

In a third implementation form, generating the first curve C from a plurality of points obtained from the mesh includes: projecting a first set of points from the edge where the first surface S₀ is incident to the second surface S₁ to the mesh to obtain a second set of points, modifying the positions of the points in the second set to obtain a third set of points wherein the distances of points in the third set from the first surface S₀ and the second surface S₁ are within a threshold of the pre-determined parameter r, and fitting the third set of points to obtain the curve C.

In a fourth implementation form, generating the first field function ƒ(x), based on the first curve C, the second curve B₀, and the third curve B₁ includes determining a blend displacement function D(x), wherein the blend displacement function D(x) is a continuous offset of a union of the first surface S₀ and the second surface S₁.

In a fifth implementation form, the blend displacement function is defined as:

$$D ( x ) = ( min ( {f}_{0} , {f}_{1} ) + ( {d}_{s} - r ) ) \cdot H ( {d}_{b} / r - δ ) ,$$

wherein dₛ includes a distance of a point x in three-dimensional space to the first curve C, wherein d_{b} includes a signed distance from a pair of half-lines γ-β₀, γ-β₁ in a section plane defined by points γ, β₀, β₁, wherein γ includes the projection of the point x on to the first curve C, wherein β₀ includes the projection of the point γ on to the curve B₀, wherein β₁ includes the projection of the point γ on to the curve B₁, and wherein H is a smooth Heaviside step function, and δ is a predetermined parameter.

In a sixth implementation form, the parameter δ is selected from a range 0.1≤δ≤0.2.

In a seventh implementation form, the first field function ƒ(x) is defined as:

$$f ( x ) = min ( {f}_{0} ( x ) , {f}_{1} ( x ) ) - D ( x ) .$$

In an eighth implementation form, generating the blend surface S based on the first field function ƒ(x) includes generating a mesh from the first field function ƒ(x).

In a ninth implementation form, generating the mesh includes applying a marching tetrahedral method or a marching cubes method to the field function ƒ(x).

In a tenth implementation form, the method includes imprinting the second curve B₀ on to the first surface S₀ and the third curve B₁ on to the second surface S₁ to obtain face sets either side of the edge where the first surface S₀ is incident to the second surface S₁, and replacing the surfaces of the face sets with the blend surface S.

In an eleventh implementation form, the method includes exporting the model of the component to an additive manufacturing device and manufacturing the component.

In a twelfth implementation form, the model of the component includes a portion including a mesh representation.

In a thirteenth implementation form, the model of the component includes a portion including a classical geometric representation.

These and other aspects of the disclosure are apparent from the embodiments described below.

### BRIEF DESCRIPTION OF THE DRAWINGS

For a more complete understanding of the present disclosure, and the advantages thereof, reference is now made to the following descriptions taken in conjunction with the accompanying drawings.

FIG. 1 shows a schematic illustration showing a cross-sectional view of surfaces of a component, according to an example.

FIG. 2 shows a schematic illustration showing a cross-sectional view of surfaces of a component, according to an example.

FIG. 3 shows a schematic perspective illustration of a spine for generating a blend surface, according to an example.

FIG. 4 shows a schematic perspective illustration of a portion of a mesh representation of a surface, according to an example.

FIG. 5 shows a schematic illustration showing a cross-sectional view of surfaces of a component, according to an example.

FIG. 6 shows a schematic perspective illustration of a blend surface, according to an example.

FIG. 7 shows a schematic perspective illustration of surfaces, according to an example.

FIG. 8 shows a schematic perspective illustration of a blended surface, according to an example.

FIG. 9 shows a flow chart illustrating methods in accordance with various embodiments.

FIG. 10 shows a schematic representation of an example of a data-processing system configured to carry out the embodiments.

### DETAILED DESCRIPTION

Example embodiments are described below in sufficient detail to enable those of ordinary skill in the art to embody and implement the systems and processes described herein. It is important to understand that embodiments may be provided in many alternate forms and should not be construed as limited to the examples set forth herein.

Accordingly, while embodiments may be modified in various ways and take on various alternative forms, specific embodiments thereof are shown in the drawings and described in detail below as examples. There is no intent to limit the particular forms disclosed. On the contrary, all modifications, equivalents, and alternatives falling within the scope of the appended claims may be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular may number one or more, unless the context clearly indicates otherwise. The terms “comprises,” “comprising,” “includes,” and/or “including,” when used herein, specify the presence of stated features, items, acts, operations, elements, and/or components, but do not preclude the presence or addition of one or more other features, items, acts, operations, elements, components, and/or groups thereof.

Unless otherwise defined, all terms including technical and scientific terms used herein are to be interpreted as is customary in the art. Terms in common usage may also be interpreted as is customary in the relevant art and not in an idealized or overly formal sense unless expressly so defined herein.

The methods described herein may be used to generate blends between surfaces of objects in, for example, CAD systems. According to examples, the surfaces may be surfaces of components that are represented in a ‘mixed representation,’ which includes parts in both classical geometry and mesh or faceted-based geometry. The methods described herein produce blends that are visually similar to rolling-ball blends, but which are compatible with mesh-based geometry as well as classic geometry using implicit methods.

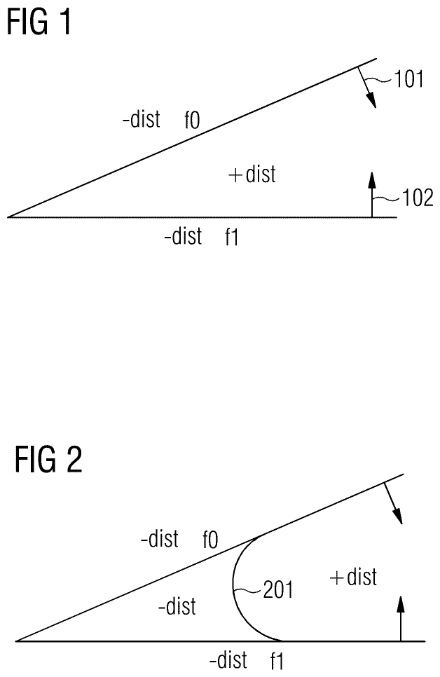

FIG. 1 is a schematic illustration showing a cross-sectional view of two surfaces S₀, S₁. The surfaces S₀, S₁ may correspond to surfaces of a model that represents a component for manufacture or a simulation of a component in a CAD system, for example. The surfaces S₀, S₁ are represented implicitly by field functions ƒ₀, ƒ₁, where each ƒᵢ is a function ƒᵢ: [symbol] ³→ [symbol] and ƒᵢ(x)=0 on the surface Sᵢ. In this description the term isosurface refers to a surface of points x in three dimensional space, where for a scalar function ƒ: [symbol] ³→ [symbol] , ƒ(x)=c where c is a constant. The term ‘under-surface’ refers to a surface that is underneath a blend surface.

In FIG. 1, the field functions ƒᵢ represent signed distances from points x∈ [symbol] ³ to the surface Sᵢ, where the sign is defined by surface normal directions 101, 102. The regions where the functions ƒᵢ are positive and negative are represented as “−dist” and “+dist”. For a concave edge, the scalar function ƒ(x)=min(ƒ₀(x), ƒ₁(x)) describes a surface that matches the two underlying surfaces S₀, S₁ when ƒ(x)=0.

FIG. 2 is a schematic illustration showing a cross sectional view of the two surfaces S₀, S₁ and a blend surface 201, which is similar to a rolling-ball type blend between the surfaces S₀, S₁. In traditional rolling-ball blending methods a blend is generated by rolling an imaginary ball along selected sharp edges of a model, where the user wishes to create a blend. This has the effect of smoothing out the selected edges. The center of the ball follows a path called a spine curve that lies at a distance equal to the radius of the ball from each of the surfaces S₀, S₁.

In FIG. 2, the shape of the blend surface 201 is controlled by a blend displacement function D(x). The method presented herein describes how to choose an appropriate function D(x) to generate the rolling-ball type blend surface 201. The blend displacement function D(x) is a continuous offset of the union of the surfaces S₀, S₁. The blend surface 201 is an isosurface of a function ƒ_{B}(x)=min(ƒ₀(x), ƒ₁(x))−D(x), which represents a signed distance from a point x∈ [symbol] ³ to the blend surface 201. The regions where the function ƒ_{B}(x) is positive and negative are represented as “−dist” and “+dist”.

The blend displacement function D(x) is determined based on three curves in three-dimensional space: a first curve C that is similar to a spine curve in a rolling-ball blend, a second curve B₀ that corresponds to a projection of the curve C on to the surface S₀, and a third curve B₁ that corresponds to the projection of the curve C on to the surface S₁.

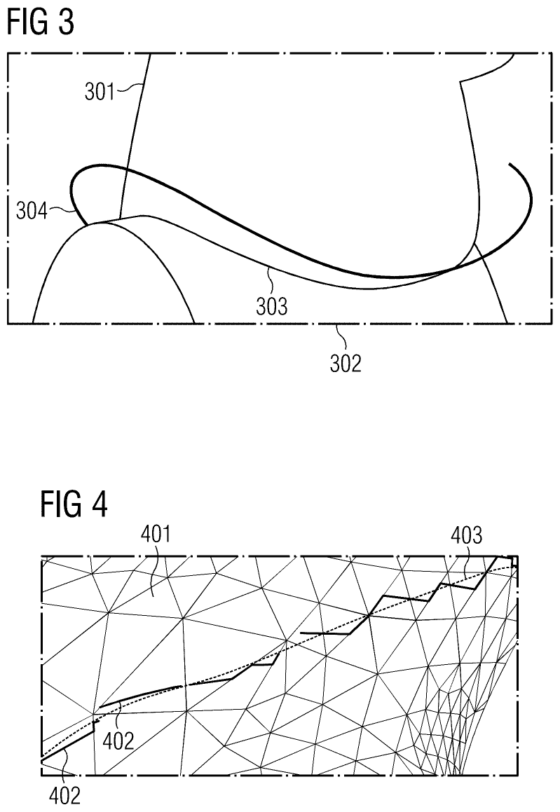

FIG. 3 is a schematic illustration showing a spine for generating a blend surface, according to an example. The illustration in FIG. 3 shows two surfaces 301, 302 that meet at an edge 303. Two sets of faces representing the surfaces 301, 302 are generated, adjacent to the edge 303. For each face set, a faceted sheet is created where all the face meshes are merged into one mesh.

A narrow tube-like mesh 304 is constructed that follows a curve, similar to a spine curve that would be used to generate a rolling-ball blend. The tube may be constructed from the following field function:

$${f}_{spine} ( x ) = \sqrt{{( {f}_{0} ( x ) - r )}^{2} + {( {f}_{1} ( x ) - r )}^{2}} - λ \qquad ( 1 )$$

In equation (1), r is a blend radius, and λ is a parameter used to control the radius of the tube. The parameter λ may be set to λ=0.04r, for example.

Samples from the edge 303 are projected to the spine mesh 304. The projected positions may be moved closer to the theoretical spine curve, which includes the points lying at a distance r from the surfaces 301, 302. A position is moved on the section plane defined by three positions: the position and its projected positions to the surfaces 301, 302, to try and find a point that lies at a distance equal to the parameter r from the surfaces 301, 302. The projected samples are fitted to a curve C, which is close to the theoretical spine curve.

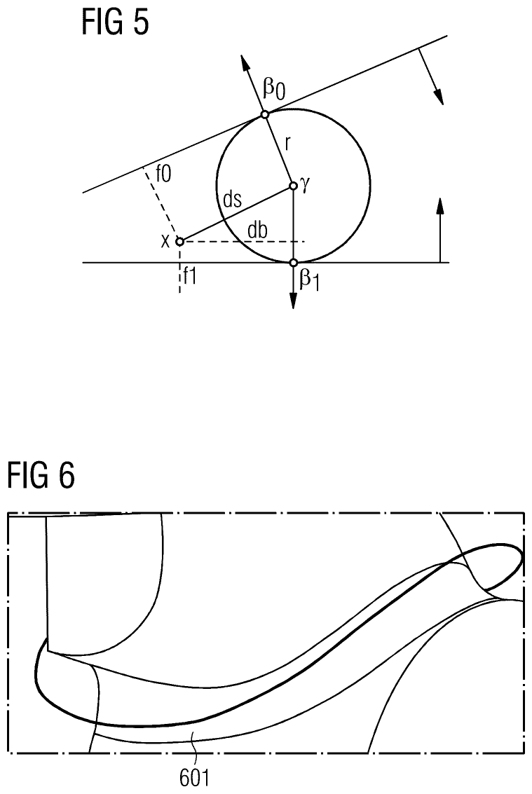

Points of the curve C are projected to the under surfaces 301, 302 to generate blend bound curves B₀ and B₁, which delimit the extent of the blend surface. FIG. 4 is a schematic perspective illustration showing projections of points of the curve C to a mesh under surface 401. Care is needed for high curvature under regions where no curve positions are projected as this produces large gaps in the projection. When an undersurface is a mesh, the projected polyline 402 from points on the curve C may be coarse. The resulting projection may be smoothed using a filter, such as a Savitzky-Golay filter, resulting in a curve 403.

FIG. 5 is a schematic illustration showing a cross sectional view of the two surfaces S₀, S₁. The point x corresponds to a position in three-dimensional space. The point γ corresponds to the position of the projection of the point x curve C described in FIG. 3 in a cross-sectional view. Similarly, β₀ and β₁ correspond to the projections of the point γ on to the blend bound curves B₀ and B₁, respectively. Further, f₀ and f₁ are signed distances from the under meshes for surfaces S₀, S₁. Additionally, ds=|X̅γ̅| is the distance from the curve C, db is a signed distance from a pair of half lines γ-β₀, and γ-β₁ in a section plane defined by points γ, β₀, β₁. The blend displacement function D(x) is defined as:

$$D ( x ) = ( min ( {f}_{0} , {f}_{1} ) + ( {d}_{s} - r ) ) \cdot H ( {d}_{b} / r - δ ) \qquad ( 2 )$$

In equation (2), the function H is a smooth version of the Heaviside step function. This provides that the blend displacement is zero beyond the blend bound curves. The value δ is selected to provide the blend bound D(x) is small and the blend mesh will be near coincident with the under-surface. A suitable value of δ may be selected from the range 0.1≤δ≤0.2, for example, δ=0.15. FIG. 6 is a schematic illustration showing a blend surface 601, according to an example. The blend surface corresponds is an isosurface of the field function:

$${f}_{B} ( x ) = min ( {f}_{0} ( x ) , {f}_{1} ( x ) ) - D ( x ) \qquad ( 3 )$$

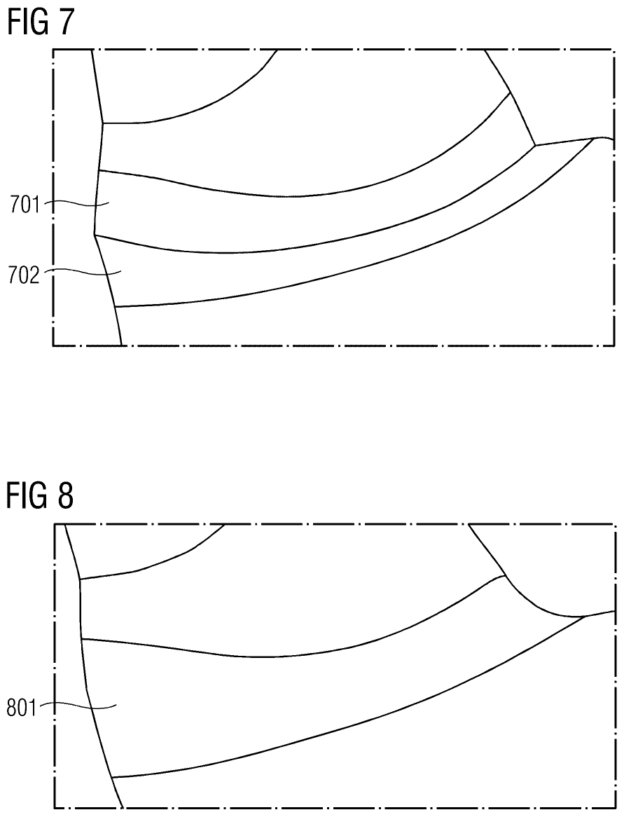

FIG. 7 is a schematic illustration showing the imprinting of blend bound curves on a body. The blend bound curves B₀ and B₁ may be imprinted directly on to the surfaces S₀, S₁, as shown in FIG. 7. Imprinting creates chains of faces 701, 702 either side of the edge chain. FIG. 8 is a schematic illustration showing a blend. In FIG. 8, the blend surface 801 replaces the surfaces of the newly created faces 701,702, which are merged into one face.

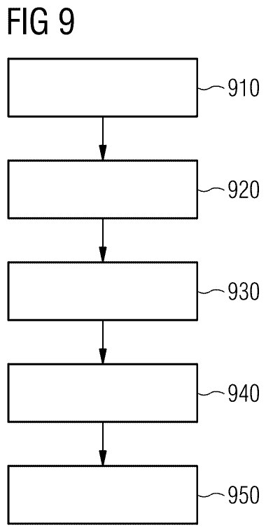

FIG. 9 shows a flow diagram of a computer implemented method for generating a blend surface for a model of a component including a first surface S₀ and a second surface S₁ adjacent to the first surface S₀.

At block 910, the method includes determining a first curve C in three-dimensional space, wherein, for each point on the first curve C, the distance of the point from the first surface S₀ and the distance of the point from the second surface S₁ is within a threshold of a pre-determined parameter r.

At block 920, the method includes determining a second curve B₀. The second curve B₀ includes a projection of the first curve C on to the first surface S₀.

At block 930, the method includes determining a third curve B₁. The third curve B₁ includes a projection of the first curve C on to the second surface S₁.

At block 940, the method includes generating a first field function ƒ(x) based on the first curve C, the second curve B₀, and the third curve B₁. The first field function ƒ(x) includes a signed distance from a point in three-dimensional space to a blend surface S between the first surface S₀ and the second surface S₁.

At block 950, the method includes generating the blend surface S based on the first field function ƒ(x).

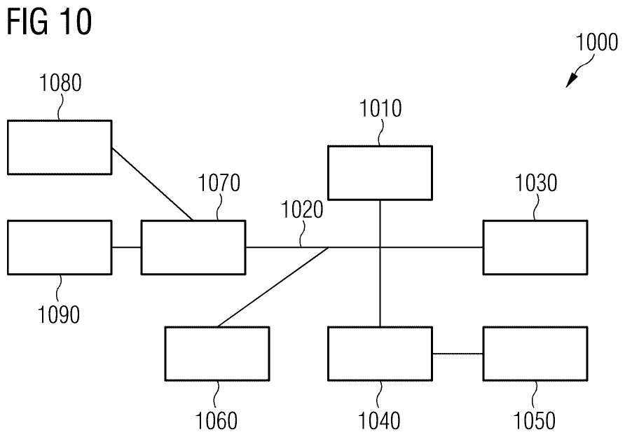

FIG. 10 illustrates an example of a data processing system in which an embodiment of the present disclosure may be implemented, for example, a CAD system configured to perform processes as described herein. The data processing system 1000 includes a processor 1010 connected to a local system bus 1020. The local system bus 1020 connects the processor to a main memory 1030 and graphics display adaptor 1040, which may be connected to a display 1050. The data processing system 1000 may communicate with other systems via a wireless user interface adapter connected to the local system bus 1020, or via a wired network, for example, to a local area network. Additional memory 1060 may also be connected via the local system bus 1020. A suitable adaptor, such as wireless user interface adapter 1070, for other peripheral devices, such as a keyboard 1080 and mouse 1090, or other pointing device, allows the user to provide input to the data processing system. Other peripheral devices may include one or more I/O controllers such as USB controllers, Bluetooth controllers, and/or dedicated audio controllers (connected to speakers and/or microphones). Various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system 1000. Further, devices referred to as input devices or output devices may both provide inputs and receive outputs of communications with the data processing system 1000. Further, other peripheral hardware connected to the I/O controllers may include any type of device, machine, or component that is configured to communicate with a data processing system.

An operating system included in the data processing system 1000 enables an output from the system to be displayed to the user on display 1050 and the user to interact with the system. Examples of operating systems that may be used in a data processing system may include Microsoft Windows™, Linux™, UNIX™, iOS™, and Android™ operating systems.

In addition, the data processing system 1000 may be implemented as in a networked environment, distributed system environment, virtual machines in a virtual machine architecture, and/or cloud environment. For example, the processor 1010 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 1000 may vary for particular implementations. For example, the data processing system 1000 in this example may correspond to a computer, workstation, and/or a server. However, alternative embodiments of a data processing system may be configured with corresponding or alternative components such as in the form of a mobile phone, tablet, controller board, or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 1000 may be connected to the network (not a part of data processing system 1000), which may be any public or private data processing system net-work or combination of networks, as known to those of skill in the art, including the Internet. The data processing system 1000 may communicate over the network with one or more other data processing systems such as a server (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, when referring to a data processing system, such a system may be implemented across several data processing systems organized in a distributed system in communication with each other via a network.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for generating a blend surface for a model of a component comprising a first surface S₀ and a second surface S₁ adjacent to the first surface S₀, the method comprising:
determining a first curve C in three-dimensional space, wherein, for each point on the first curve C, a distance of the respective point from the first surface S₀ and a distance of the respective point from the second surface S₁ is within a threshold of a pre-determined parameter r;
determining a second curve B₀, the second curve B₀ comprising a projection of the first curve C onto the first surface S₀;
determining a third curve B₁, the third curve B₁ comprising a projection of the first curve C onto the second surface S₁;
generating a first field function ƒ(x) based on the first curve C, the second curve B₀, and the third curve B₁, wherein the first field function ƒ(x) comprises a signed distance from a point in the three-dimensional space to a blend surface S between the first surface S₀ and the second surface S₁; and
generating the blend surface S based on the first field function ƒ(x).

2. The method of claim 1, wherein the first surface S₀ is an isosurface of a second field function ƒ₀(x), and
wherein the second surface S₁ is an isosurface of a third field function ƒ₁(x).

3. The method of claim 2, wherein the determining of the first curve C comprises:
determining a fourth field function ƒₛₚᵢₙₑ(x):
$${f}_{spine} ( x ) = \sqrt{{( {f}_{0} ( x ) - r )}^{2} + {( {f}_{1} ( x ) - r )}^{2}} - λ ;$$
generating a mesh based on the fourth field function ƒₛₚᵢₙₑ(x); and
generating the first curve C from a plurality of points obtained from the mesh,
wherein λ is a parameter such that λ/r is less than a pre-determined value.

4. The method of claim 3, wherein the generating of the first curve C comprises:
projecting a first set of points from an edge where the first surface S₀ is incident to the second surface S₁ to the mesh to obtain a second set of points;
modifying positions of points in the second set of points to obtain a third set of points, wherein distances of points in the third set of points from the first surface S₀ and the second surface S₁ are within the threshold of the pre-determined parameter r; and
fitting the third set of points to obtain the curve C.

5. The method of claim 2, wherein the generating of the first field function ƒ(x) comprises determining a blend displacement function D(x), and
wherein the blend displacement function D(x) is a continuous offset of a union of the first surface S₀ and the second surface S₁.

6. The method of claim 5, wherein the blend displacement function is defined as:
$$D ( x ) = ( min ( {f}_{0} , {f}_{1} ) + ( {d}_{s} - r ) ) \cdot H ( {d}_{b} / r - δ ) ,$$
wherein:
dₛ comprises a distance of a point x in the three-dimensional space to the first curve C,
d_{b} comprises a signed distance from a pair of half-lines γ-β₀, γ-β₁ in a section plane defined by points γ, β₀, β₁,
γ comprises the projection of the point x on to the first curve C,
β₀ comprises the projection of the point γ on to the curve B₀,
β₁ comprises the projection of the point γ on to the curve B₁,
H is a smooth Heaviside step function, and
δ is a predetermined parameter.

7. The method of claim 6, wherein δ is selected from a range 0.1≤δ≤0.2.

8. The method of claim 6, wherein the first field function ƒ(x) is defined as:
$$f ( x ) = min ( {f}_{0} ( x ) , {f}_{1} ( x ) ) - D ( x ) .$$

9. The method of claim 1, wherein the generating of the blend surface S comprises generating a mesh from the first field function ƒ(x).

10. The method of claim 9, wherein the generating of the mesh comprises applying a marching tetrahedral method or a marching cubes method to the field function ƒ(x).

11. The method of claim 9, further comprising:
imprinting the second curve B₀ on to the first surface S₀ and the third curve B₁ onto the second surface S₁ to obtain face sets either side of the edge where the first surface S₀ is incident to the second surface S₁; and
replacing the surfaces of the face sets with the blend surface S.

12. The method of claim 1, further comprising:
exporting the model of the component to an additive manufacturing device and manufacturing the component.

13. The method of claim 1, wherein the model of the component comprises a portion comprising a mesh representation.

14. The method of claim 1, wherein the model of the component comprises a portion comprising a classical geometric representation.

15. A data processing system comprising:
a processor configured to:
determine a first curve C in three-dimensional space, wherein, for each point on the first curve C, a distance of the respective point from the first surface S₀ and a distance of the respective point from the second surface S₁ is within a threshold of a pre-determined parameter r;
determine a second curve B₀, the second curve B₀ comprising a projection of the first curve C onto the first surface S₀;
determine a third curve B₁, the third curve B₁ comprising a projection of the first curve C onto the second surface S₁;
generate a first field function ƒ(x) based on the first curve C, the second curve B₀, and the third curve B₁, wherein the first field function ƒ(x) comprises a signed distance from a point in the three-dimensional space to a blend surface S between the first surface S₀ and the second surface S₁; and
generate the blend surface S based on the first field function ƒ(x).
